(19) United States
(12) Patent Application Publication
(10) Pub. No.: US 2009/0286092 A1
(43) Pub. Date: Nov. 19, 2009

(54) Composite made of leather and a further material

(76) Inventor: Esfandiar Rahim Azar-Pey, Schlangenbad (DE)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(21) Appl. No.: 11/990,903

(22) PCT Filed: Nov. 11, 2005
(86) PCT No.: PCT/EP2005/012117

§ 371 Date: Mar. 20, 2009

(30) Foreign Application Priority Data
Aug. 24, 2005 (DE) 10 2005 040 078.7

(51) Int. Cl. B32B 9/02; B32B 15/04; B32B 37/12

(52) U.S. Cl. 428/457; 428/473; 156/60; 156/278

(57) ABSTRACT

The present invention relates to a composite comprising at least one layer of kid leather or fish leather or a combination of kid and fish leather and at least one further layer of a material selected from a group comprising: Metals, metal alloys, plastics, fiber composites as well as a process for the manufacture of such a composite and its use for interior decoration and outer lining of, among others, automobiles and for the outer or inner lining of objects.

The present invention relates to a composite comprising at least one layer of kid leather or fish leather or a combination of kid and fish leather and at least one further layer of a material selected from a group comprising: Metals, metal alloys, plastics, fiber composites as well as a process for the manufacture of such a composite and its use for interior decoration and outer lining of, among others, automobiles and for the outer or inner lining of objects.

Various applications for leather in general are known from the prior art. In particular, bulls leather, calf leather and pigskin are used for a number of applications such as in the clothing industry and for upholstering. Bulls leather, calf leather as well as pigskin, however, are disadvantageous in the sense that they have to have a relatively high strength or thickness in order to result in a tear strength necessary for processing. Kid leather, on the other hand, has a much higher tear strength already at a lower thickness and is also lighter than bulls leather of a comparable thickness due to its low density.

In contrast to bulls leather, calf leather and pigskin, kid leather is outfitted with a naturally shagreen surface. Therefore, kid leather is used in particular for the manufacture of noble shoes and kid velour leather jackets. Fish leather is also and particularly used for the preparation of clothing items and bags due to its scale pattern that is visible after the tanning process.

In the furniture area, it is common practice to apply leather onto a support of wood in order to refine the respective piece of furniture by using leather in selected places, such as back rests and arm rests. Thereby, the wood as well as the leather have to be selected to be present in sufficient strength so that the composite made of wood and leather withstands the use intended for the individual piece of furniture The strength necessary to achieve this, in particular the strength of the wooden part, however, results in limitations imposed on the possible design of objects that are made of wood lined with leather. For example, three-dimensional shaped hollow blocks made of wood are achievable, if at all, only by means of elaborate additional processing of the wood.

The use of a composite made of wood and leather, in particular bulls leather and calf leather, is also known from the automobile industry with respect to the interior decoration of so-called luxury cars. As a disadvantage in this respect, next to the limited design possibilities of such a composite, it has to be mentioned, that its relatively high weight results from the necessary strength of the wood and of the leather.

Therefore, an object of the present invention is to provide a composite made of leather and one further material that may be shaped with respect to its intended use at a low empty weight.

This object is solved by a composite, comprising at least one layer of kid leather or fish leather or a combination of kid and fish leather and at least one further layer of a material selected from a group comprising: Metals, metal alloys, plastics, fiber composites as well as a combination of two or more of the aforementioned materials.

In case the composite comprises at least one layer comprising a combination of kid leather and fish leather, the different types of leather can be connected with each other, in the framework of such a combination, in any conceivable manner as to result in the desired patterns. In a preferred embodiment, the pieces of leather of the two kinds which are, according to their intended use, of the same or of a different size, or connected with each other to result in one layer.

The advantage of this composite is that due to the material selected (selected from a group comprising: Metals, metal alloys, plastics, fiber composites as well as a combination of two or more of the aforementioned materials), there are hardly any limits with respect to shape forming of this composite compared to a composite made of wood and leather. The materials as mentioned can be manufactured in any desired shape adapted to the respective necessities.

The use of kid leather or fish leather results in a further advantage since both types of leather are very elastic due to their structure and are able to work under unusually high tensile loading at a given low empty weight. Furthermore, it is emphasized that both types of leather have a high resistance against solar irradiation while keeping their outer shape.

All metals and metal alloys known to the person skilled in the art can be used in principle. Iron, copper, nickel, as well as the noble metals such as silver, gold and platinum are suited for usage in the framework of the composite according to the invention. In the framework of the present composite, alloys made of metals or of alloys with one or more non-metals, such as bronze, brass, or steel can be used.

Preferably, aluminum is used, particularly preferred fireproof aluminum. Next to its long durability and its low density, aluminum provides the further advantage that it is isolating with respect to sound and does not need to be maintained. Aluminum alloys are also preferred, in particular together with magnesium, silicon and other metals, such as titanium, since these alloys achieve a particularly high stability at low weight.

Using plastics as materials for the one further layer is also preferred. In comparison to wood, these materials have the further advantages, next to their low weight, that they may be manufactured in any desirable form in a simple and cost effective manner. Furthermore, they are durable with respect to their shape and resistant with respect to atmospheric conditions. All plastic materials known to the person skilled in the art can be employed in principle. Thermoplastic and duroplastic materials are preferred. From the area of thermoplastic materials, next to polypropylene (PP), polyethylene (PE), polyethylene therephthalate (PET) and polystyrol (PS), the following may be used as well: Polyacetal (POM), polyamide (PA), polybutylene therephthalate (PBT), polyethersulfonate (PES), polycarbonate (PC), polyphenylenesulfide (PPS), polytetrafluorethylene (PTFE), polyether etherketon (PEEK), polyimide (PI), or a polyblend, a mixture of two ore more thermoplastic materials. From the field of duroplastic materials, bakelite as well as synthetic resins such as epoxides are used in particular. Preferred are acrylnitrile/butadiene/styrol copolymers (ABS), ABS+PC (polycarbonate) as well as PA6. In a further preferred embodiment, polyurethane (PUR) is also employed, in particular flexible PUR integral foamed materials, hard PUR integral foamed materials as well as fiberglass-reinforced integral foamed materials (R-RIM).

Fiber composite materials are also suited to be used as a further layer in the composite according to the invention, in particular due to their high strength at low thickness. Therefore, it is possible to use fiber-reinforced plastic materials as well as other fiber-reinforced materials such as concrete, artificial stone material as well as metals as a further layer.

Fiber-reinforced plastic materials are also particularly suited as a further layer, wherein the plastic materials are selected from a group consisting of duroplastic plastic materials, in particular synthetic resins, elastomeric plastic materials as well as thermoplastic materials. All fibers known to the person skilled in the art can be used as fibers for reinforcing, such as glass fibers, carbon fibers, aramide fibers, boron fibers, steel fibers, natural fibers as well as nylon fibers. Particularly preferred fiber composite materials are glass fiber-reinforced plastic materials, carbon fiber-reinforced plastic materials as well as aramide fiber-reinforced plastic materials such as Kevlar® of Du Pont.

For the at least one further layer, technical plastic materials that are unfilled or filled with glass fibers on the basis of ABS or ABS+PC or technical plastic materials that are filled with minerals are particularly preferred.

Furthermore, a layer can be used as the further layer in the framework of the composite according to the present invention that is a combination of one or more materials selected from the group consisting of: Metals, metal alloys, plastics, fiber composites.

In a further embodiment of the invention the at least one further layer is made of natural or artificial stone instead of the aforementioned materials and is connected with the at least one layer made of kid leather or fish leather or a combination of both types of leather. Any material that is tied with polyester resin and that has up to 80% of mineral components is suited as an artificial stone. Artificial stone has the particular advantage compared to wood that the artificial stone has a high strength with respect to pressure load and shear tensile load. Furthermore, artificial stone is resistant with respect to atmospheric conditions. Also, thin-walled objects may be manufactured in particular from artificial stone.

Also, a layer of a combination of one or more of the aforementioned materials with natural or artificial stone may be employed in the framework of the composite according to the present invention.

In principle, the material used can be employed in any desirable layer thickness in the composite as long as it achieves sufficient stiffness as to not deform upon being connected with the leather that is, as the case may be, stretched.

The composite comprises furthermore at least one layer of kid leather or fish leather or a combination of kid leather and fish leather The kid leather or the fish leather can in principle be employed in the composite according to the invention in a processed or in a unprocessed form. However, the leather is preferably employed in a tanned form. For preparing the fish leather, in principle the skin of all fishes may be used, for example, trout, salmon, bass, catfish, sturgeon and shagran. The skins of fishes that are capable of being present in sweet as well as in salt water are employed in a preferred embodiment, for example, salmon skin.

Tanning processes for the skins of mammals as well as tanning processes for fish skin are known in the prior art. For example, DE 35 34 353 discloses a process for manufacturing fish leather. Within the scope of the tanning processes, the kid leather or the fish leather as used may optionally also be dyed or bleached. A leather that is left in its natural color, that is dyed in a color or that is bleached is employed in a preferred embodiment. The use of dyed leather is particularly preferred. All suitable colors known to the person skilled in the art can be used for dying the leather. In a preferred embodiment, dyes that are compatible with the environment are used. A completely colored layer of leather, i. e. a layer that is colored or bleached on both sides, is obtained by means of dying or bleaching the kid leather or the fish leather during the tanning process.

By means of executing the dying or the bleaching process after the tanning process, a layer of leather may be obtained that is only bleached or colored on one side. Dying or bleaching the leather following the tanning process is associated with the advantage that the leather may be adapted in an individual manner to the requirements of the respective use of the composite according to the invention, without limitation that the field of use already has to be determined before the step of tanning the kid skins.

Normally, the leather comprises, after the tanning process, two different surfaces that are distinct from each other at least with respect to their optical appearance.

The surface that is termed as the outer side has, with respect to kid leather, a shagreen that is typical for kid leather and is optically more pleasant than the second surface that is termed as the interior side. With respect to fish leather, the surface that is termed as the outer side has the characteristic scale pattern that is indicative for the type of fish used, respectively. In principle, the at least one layer made of leather can be connected with the layer made of at least one further material via the inner side or via the outer side. However, it is preferred that the composite is arranged in a manner so that the leather is connected with the further layer of a material via its inner side and is therefore directed with its outer side towards the spectator.

Furthermore, the present invention also relates to a composite of the kind as described above, wherein at least one layer is made of kid leather or of fish leather or of a combination of both types of leather, wherein the outer side is coated with at least one means for coating.

All materials known to the person skilled in the art for this use may be used as the means for coating in principle, as long as they can be applied on the outer side of a leather that is tanned and optionally dyed. The outer side of the at least one layer of leather may be coated with natural materials, modified natural materials, synthetic materials or a combination thereof.

The outer side of the leather may also be treated with various naturally occurring oils, such as linseed oil or wood seed oil, but also with cellulose esters or cellulose ethers and rubber derivatives, as well as with various mixtures of oil acids and fatty acids. By means of this treatment of the surface, a further layer forms on the outer side of the respective leather, having the advantage that the leather is protected against atmospheric conditions without loosing the natural softness of the kid leather or the fish leather. If the outside of the leather is treated with a varnish on the basis of latex, said varnish is preferably applied onto the outer side with the aid of a so-called stopper by hand.

In the context of the present invention it is preferred that the outside of the leather is coated with a synthetic varnish. Therein, a liquid or a powderous substance is applied to outside of the leather and a coherent film is built or formed thereon by means of chemical or physical processes. The coating material thereby chosen may be applied by means of coating, rolling, spraying with or without pressurized air, or electrostatically, as well as by means of dipping, rolling, pouring or flooding on the outer side of the at least one layer of kid leather.

In principle, depending on the intended use of the composite according to the invention, a suitable varnish may be chosen that has protective and/or decorative functions.

In the framework of the present invention it is furthermore of advantage to coat the outer side of the at least one layer made of kid leather or of fish leather or of a combination of the two types of leather with a UV-protecting varnish if the composite is to be used in the outside area. In particular, the leather is protected from discoloration as inflicted by means of UV-irradiation if a UV-protective varnish is used. It is also advantageous to use a commercially available car clear varnish, in particular a nanovarnish, for coating the outer side of the at least one layer of kid leather or fish leather or a combination of the two types of leather. This coating has the advantage, in addition to protection from discoloration by means of UV-light that the outer side of the leather is made insensitive against physical damages such as scratches and is also rendered resistant against atmospheric conditions. Furthermore, the varnishes may be transparent or may contain additives such as color imparting pigments or structure imparting additives. These may alter the optical appearance of the outer surface of the at least one layer made of kid leather or fish leather or of a combination of both types of leather with respect to color and structure.

The outer side of the at least one layer of kid leather or fish leather or of a combination of both types of leather may also be coated with a coating material on the basis of polyurethane, the outer side therefore being particularly protected from attrition and from penetration by water and dirt.

It is particularly preferred that the coating of the outer side of the leather is performed with a means for coating comprising polyester. By means of coating with polyester, the outer side of the leather layer is made water resistant as well as resistant against aging and against chemicals. After the means for coating comprising the polyester resin has been applied to the outer side of the leather layer, network formation can be accelerated by means of employing a polymerization catalyst and by reducing the networking temperature. A peroxide catalyst is particularly suited as the polymerization catalyst.

If the composite comprises more than one layer of kid leather or of fish leather or of a combination of both two types of leather, those layers are arranged in a manner that at least the uppermost layer as directed towards the spectator of the composite is arranged so that its outer side points towards the top. In the framework of such a composite, it is sufficient that only the uppermost layer that is directed towards the spectator of the composite and that is made of kid leather or of fish leather or of a combination of those two types of leather is coated on its outer side with a means of coating.

Furthermore, the present invention is also directed to a process for manufacturing a composite as described above.

The process according to the invention comprises the following steps:
(i) Preparation of the at least one layer of kid leather or of fish leather or of a combination of kid leather and of fish leather;
(ii) connecting the at least one layer of kid leather or of fish leather or of a combination of kid leather and of fish leather with the at least one further layer made of a material selected from a group comprising: Metals, metal alloys, plastics, fiber composites as well as a combination of two or more of the aforementioned materials;
(iii) optionally coating of the outer side of the at least one layer of kid leather or of fish leather or of a combination of kid leather and fish leather with at least one means for coating,
   wherein step (iii) may be executed in between steps (i) and (ii) or subsequent to step (ii).

Preparation step (i) that relates to the preparation of at least one layer of kid leather or fish leather or of a combination of kid leather and fish leather for connecting this layer with at least one further layer made of a material selected from the group comprising: Metals, metal alloys, plastics, fiber composites as well as a combination of two or more of the aforementioned materials, comprises at least the tanning of the respective kid leather or fish leather. The tanning process may be performed by means of all tanning processes known to the person skilled in the art in respect to kid leather or fish leather. With respect to kid leather, all tanning processes known to the person skilled in the art for the skins of mammals are suitable. With respect to the tanning of fish leather, particular preference is made to the process according to DE 35 34 353.

Step (i) may also comprise the dyeing or bleaching of the skins during the tanning process or of the leather after the tanning process. Furthermore, step (i) may also comprise the sanding of the outer and/or inner side of the layer of kid leather or of fish leather or of a combination of kid leather and of fish leather. In the framework of step (i) the layout as well as the assembly of the skins or of the leather as to achieve the form and the size as necessary for later processing may also be performed already before or after the tanning step. This also relates to the connecting of the fish leather and the kid leather to a combination of both types of leather in the desired size. The connecting of the skins or of the leather is performed by using all processes known to the person skilled in the art such as tacking, riveting, stitching or glueing. In a preferred embodiment, the stitching together or the glueing together to arrive at the pattern as desired respectively is performed so that the size as necessary for the intended use is achieved.

Step (ii) comprises the connecting of the at least one layer of kid leather or of fish leather or of a combination of kid leather and fish leather with at least one further layer made of a material selected from the group comprising: Metals, metal alloys, plastics, fiber composites as well a combination of two or more of the aforementioned materials. In principle, the connecting of the at least two layers can be performed by means of all techniques of connecting that are known to a person skilled in the art and that may lead to releasable or non-releasable connections. For example, it is possible, to connect the at least one layer of leather with the at least one further layer of a aforementioned material by means of fastening means such as screws as to arrive at a releasable connection.

In the framework of the present invention, however, the processing steps that lead to a non-releasable connection are preferred such as tacking, glueing, riveting and stitching. In a particularly preferred embodiment, the connecting of the at least one layer of fish leather or of kid leather or of a combination of the two types of leather with the at least one further layer of the aforementioned materials is achieved by gluing these together. The particular advantage of this technique of connecting is given by the fact that an even distribution of tension and transfer of force is achieved over the entire glueing area between the leather layer and the further layer made of one of the aforementioned materials. Thereby, it is possible to apply the leather in an even manner and without crumpling onto the further layer of material. This allows for an even optical appearance of the leather layer. With respect to the glueing materials, all materials known to person skilled in the art for this purpose are suitable. An adhesive based on vinyl basis is particularly preferred.

Furthermore, step (ii) may also comprise processing steps that serve to strengthen the connections established between the layers. Such a further processing step is, for example, provided by machine pressing of the two layers that are connected to each other or the processing of the composite layer by means of a respective tool, preferably a hammer. The processing of the respective outer side of the leather that has been connected with a further layer of one of the aforementioned materials can be performed by means of a hammer by using the hand or by using a machine.

In the framework of step (ii) the layers of leather and of the aforementioned material may be connected in the form of yet unshaped layers as well as in the form of layers that have already been shaped with respect to their intended use.

Step (iii) optionally comprises the coating of the outer side of the at least one layer of kid leather or of fish leather or of a combination of those two types of leather with at least one means for coating, wherein said step can be performed in between steps (i) and (ii) or subsequent to step (ii).

In principle, the respective means for coating can be applied onto the tanned and optionally dyed, but otherwise untreated outer side of the at least one layer of kid leather or of fish leather or of a combination of both types of leather. However, the outer side may also be sanded in preparation thereof. The sanding of the outer side of the leather is associated with the advantage that the adhesion between a layer of a means for coating and the outer side of the leather may be improved. In particular, if the coating is achieved by means of a means for coating based on polyurethane or polyester, the sanding as optionally employed on the outer side of the leather should be performed in a manner so that the shagreen as already present or the scale pattern of the supporting layer, respectively, is mostly preserved.

If the shagreen layer or the layer that supports the scale is completely removed, the liquid means for coating penetrates into the leather layer and therefore could lead to a hardening thereof.

In particular, if a means for coating on the basis of polyester is used, the coating may be further processed, after hardening, by means of polishing and applying a further clear varnish. In an alternative embodiment, one or more further layers of polyester resin or of another means for coating may be applied onto a first, hardened, polyester layer. Thereby the surface is again polished after hardening by means of a machine or by hand. Polishing of the surface can be achieved by means of every means known to the person skilled in the art and suited therefore. In the framework of the present invention, the surface is polished by means of polishing papers of different degrees of fineness and by a subsequent treatment with so-called polishing paste or a fine polishing wax. It is also possible to immediately polish the surface with polishing paste or polishing wax. Furthermore, it is possible to polish the surface with the aid of a acetylene flame that should burn as rich in oxygen as possible. In a particularly preferred embodiment of the present invention, the surface is polished by means of a polishing paste.

In case that the connecting of the at least one layer of kid layer or of fish leather or of a combination of kid leather and fish leather with at least one further layer of a material selected from the group comprising: Metals, metal alloys, plastics, fiber composites as well as a combination of two or more of the aforementioned materials has been performed in the unshaped state, subsequent to step (ii) or optionally subsequent to step (iii) a step of shape forming of the ready-to-use composite is performed corresponding to the intended use The processes that are applied herefore by the person skilled in the art are adapted to the further material that is present in the composite, wherein said further material is selected from the group consisting of: Metals, metal alloys, plastics, fiber composites well as a combination of two or more of the aforementioned materials. Thereby, a composite of the respective leather or of a combination of the two types of leather on aluminum may be, for example, bent into the respective desired shape.

In the framework of the present invention, however, it is preferred that materials are used that have already been brought into shape before step (ii), wherein the layers of these materials are selected from the group comprising: Metals, metal alloys, plastics, fiber composites as well as a combination of two or more of the aforementioned materials. These layers as shaped are connected in step (ii) with the at least one layer of kid leather or of fish leather or of a combination of kid leather and fish leather that also already may have been cut to have the corresponding shape.

Furthermore, the present invention relates to the use of the inventive composite for interior decoration as well as for the outer lining of automobiles, air-, water- or track vehicles.

For example, the composite according to the invention is used in the framework of interior decoration of automobiles, in particular of luxury cars. Thereby, for example, the panels of the instruments, door knobs and window handles as well as the trimming may be made of the inventive composite. The use of the inventive composite, in particular a composite of kid leather or fish leather or a of a combination of kid leather and fish leather with aluminum or plastic materials for any of the aforementioned uses has the advantage, compared to the use of wood or of a comparable wood composite, that the composite according to the present invention shows a higher elasticity and has a low weight which is of particular importance in the area mentioned before. Furthermore by means of using the inventive composite, parts for the interior decoration of moving objects may be formed that are not achievable in a comparable low degree of thickness by using wood due to the material properties of wood. This relates, for example, to trimmings that are strongly bent or to three-dimensional hollow shapes such as decorative trims, ash trays or the like.

The composite according to the invention is also used for the outer lining of vehicles, in particular of luxury cars. In the framework of outer lining of automobiles, the inventive composite, in particular a composite of kid leather or fish leather or of a combination of kid leather and fish leather on aluminum or on plastic materials, is manufactured in a size that corresponds to the size of the automotive part that is to be decorated, therefore allowing the incorporation during the final production steps of the automobile or subsequent thereto.

Both types of use have the advantage, in particular in comparison with the processing of wood as known from the prior art for similar purposes, that the surface may be designed in any color by means of using kid leather or fish leather or a combination of the two types of leather, so that the parts of the interior decoration made therefrom or of the outer lining can be adapted to the wishes of customers. Furthermore it is of advantage that no limits exist with respect to wishes of customers pertaining to particular forms or shapes of the interior decoration or of the outer lining due to the effect that the inventive composite may be brought into any desired form or shape.

A further advantage of the interior decoration or parts of the outer lining as manufactured from the composite according to the present invention is the low weight, thus avoiding an unnecessary increase of the overall weight of the automobile. This in turn, has positive effect on the fuel consumption of the respective vehicle.

Furthermore, the inventive composite can also be used for the outer or inner lining of objects. For example, the interior walls or the outer walls of buildings can be lined by means of the composite, thus, importing a noble appearance. It is also possible to line stairways, door knobs or housings of all kinds by means of the inventive composite. The aforementioned methods of use are associated with the advantage that it is possible to fulfil the wishes of customers with respect to decorative elements without any problem by means of an inventive composite that may be present in any shape and is light. The shape of the respective objects does not impose a limit thereon

1-11. (canceled)

12. A composite comprising at least one layer of kid leather or of fish leather or of a combination of kid and fish leather and at least one further layer of a material selected from metals, metal alloys, plastics, fiber composites and combinations of two or more of the aforementioned materials.

13. The composite of claim 12, wherein the at least one further layer is made of aluminum or an aluminum alloy.

14. The composite of claim 12, wherein the at least one further layer is made of plastics.

15. The composite of claim 12, wherein the at least one layer of kid leather or of fish leather or of a combination of kid leather and fish leather is dyed.

16. The composite of claim 12, wherein the at least one layer of kid leather or of fish leather or of a combination of kid leather and fish leather is coated on the outer side with at least one means for coating.

17. The composite of claim 16, wherein the means for coating is a varnish.

18. The composite of claim 16, wherein the means for coating comprises polyester.

19. A process for manufacturing the composite of claim 12 comprising the following steps:
(i) preparation of at least one layer of kid leather or of fish leather or of a combination of kid leather and fish leather;
(ii) connecting of the at least one layer of kid leather or of fish leather or of a combination of kid leather and fish leather with the at least one further layer of a material selected from metals, metal alloys, plastics, fiber composites and combinations of at least two or more of the aforementioned materials;
(iii) optionally coating of the outer side of the at least one layer of kid leather or fish leather or of a combination of kid leather and fish leather with at least one means for coating;
wherein step (iii) can be performed in between steps (i) and (ii) or subsequent to step (ii).

20. The process of claim 19, wherein the at least one layer of kid leather or of fish leather or of a combination of kid leather and fish leather is connected with the at least one further layer by means of a connection technique selected from the group comprising stapling, gluing, stitching and riveting.

21. A process for manufacturing interior decoration or outer lining of automobiles, air-, water- or track vehicles employing the composite of claim 12.

22. A process for manufacturing outer lining or inner lining of objects employing the composite of claim 12.
